(19) United States
(12) Patent Application Publication
(10) Pub. No.: US 2022/0207803 A1
(43) Pub. Date: Jun. 30, 2022

(54) METHOD FOR EDITING IMAGE, STORAGE MEDIUM, AND ELECTRONIC DEVICE

(71) Applicant: BOE Technology Group Co., Ltd., Beijing (CN)

(72) Inventor: Chong GUO, Beijing (CN)

(21) Appl. No.: 17/500,757

(22) Filed: Oct. 13, 2021

(30) Foreign Application Priority Data
Dec. 24, 2020 (CN) 202011555506.0

(51) Int. Cl. G06T 11/60; G06F 3/0484; G06T 11/00

(52) U.S. Cl. CPC G06T 11/60; G06T 2200/24; G06T 11/001; G06F 3/04842

(57) ABSTRACT

Provided is a method for editing an image, including: receiving, in a process of displaying an original image, an instruction triggered by a target selection operation of a user on the original image; displaying, on the original image, a trajectory of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes; and displaying, in response to an operation indicating to complete the selection and triggered by the user, a result after executing a corresponding image editing operation on the original image based on the trajectory according to the type of the target selection operation.

### CROSS-REFERENCE TO RELATED APPLICATION

This application claims priority to the Chinese Patent Application No. 202011555506.0, filed on Dec. 24, 2020 and entitled “METHOD FOR EDITING IMAGE AND CONTROL APPARATUS, STORAGE MEDIUM AND COMPUTER DEVICE”, the entire content of which is incorporated herein by reference.

### TECHNICAL FIELD

The present disclosure belongs to the technical field of image editing applications, and particularly relates to a method for editing an image, a storage medium, and an electronic device.

### BACKGROUND

At present, with rapid development of image processing technologies, it has become more and more widespread to perform reserving and removing editing on areas of an original image to acquire an image required by a user.

### SUMMARY

The present disclosure provides a method and an apparatus for editing an image, a storage medium, and an electronic device. The technical solution is as follows.

In a first aspect, the present disclosure provides a method for editing an image. The method includes:

receiving, in a process of displaying an original image, an instruction triggered by a target selection operation of a user on the original image, wherein the target selection operation includes one of an operation of selecting a reserved area in the original image and an operation of selecting a removed area in the original image;

displaying, on the original image, a trajectory of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes; and

displaying, in response to an operation indicating to complete the selection and triggered by the user, a result after executing a corresponding image editing operation on the original image based on the trajectory according to the type of the target selection operation.

Optionally, before receiving the instruction triggered by the target selection operation of the user on the original image, the method further includes:

receiving an instruction indicating to edit the original image; and

generating a canvas based on the instruction indicating to edit the original image, wherein the canvas is transparently displayed on an upper layer of the original image, and pixels in the canvas are in one-to-one correspondence with pixels in the original image; and

displaying, on the original image, the trajectory of the target selection operation acting on the original image includes:

setting the pixels for indicating the trajectory on the canvas to be non-transparently displayed.

Optionally, the canvas includes a first canvas and a second canvas which are sequentially laminated and displayed on the upper layer of the original image; wherein

an effect of highlighting the end of the trajectory on the original image is acquired by displaying the end of the trajectory in the first canvas; and

an effect of displaying the trajectory on the original image is acquired by displaying the trajectory in the second canvas.

Optionally, the method further includes:

receiving an instruction triggered by an erasing operation, wherein the erasing operation is configured to indicate to erase at least part of the trajectory; and

displaying a remaining trajectory after erasing on the original image, and highlighting an acting position of the erasing operation.

Optionally, after receiving the instruction triggered by the erasing operation, the method further includes:

displaying an erased trajectory, wherein the remaining trajectory and the erased trajectory have different display modes.

Optionally, the first canvas and the second canvas are displayed on the upper layer of the original image, pixels in the first canvas are in one-to-one correspondence with the pixels in the original image, and pixels in the second canvas are in one-to-one correspondence with the pixels in the original image;

an effect of highlighting the end of the trajectory and the acting position of the erasing operation on the original image is acquired by displaying the end of the trajectory and the acting position of the erasing operation in the first canvas; and

an effect of displaying the trajectory, the remaining trajectory after erasing and the erased trajectory on the original image is acquired by displaying the trajectory, the remaining trajectory, and the erased trajectory in the second canvas.

Optionally, after receiving the instruction triggered by the target selection operation of the user on the original image, the method further includes:

representing, based on an acting position of the target selection operation and the type of the target selection operation, the trajectory by binary data; and

displaying, in response to the operation indicating to complete the selection and triggered by the user, the result after executing the corresponding image editing operation on the original image based on the trajectory according to the type of the target selection operation includes:

displaying, in response to the operation indicating to complete the selection and triggered by the user, the result after executing the corresponding image editing operation on the original image based on the trajectory represented by the binary data according to the type of the target selection operation.

Optionally, representing, based on the acting position of the target selection operation and the type of the target selection operation, the trajectory by the binary data includes:

setting a pixel value of pixels for representing the trajectory indicating the reserved area in a third canvas to one of 0 and 1, and setting a pixel value of pixels for representing the trajectory indicating the removed area in the third canvas to the other of 0 and 1, wherein positions of the pixels in the third canvas are in one-to-one correspondence with positions of the pixels in the original image.

Optionally, after displaying, on the original image, the trajectory of the target selection operation acting on the original image, the method further includes:

representing, in response to the operation indicating to complete the selection and triggered by the user, the trajectory by binary data based on an acting position of the target selection operation and the type of the target selection operation; and

displaying, in response to the operation indicating to complete the selection and triggered by the user, the result after executing the corresponding image editing operation on the original image based on the trajectory according to the type of the target selection operation includes:

displaying, in response to the operation indicating to complete the selection and triggered by the user, the result after executing the corresponding image editing operation on the original image based on the trajectory represented by the binary data according to the type of the target selection operation.

Optionally, displaying the result after executing the corresponding image editing operation on the original image based on the trajectory according to the type of the target selection operation includes:

sending the trajectory and the original image to a server;

receiving the result after executing the corresponding image editing operation on the original image by the server based on the trajectory according to the type of the target selection operation; and

displaying the result.

Optionally, displaying the result after executing the corresponding image editing operation on the original image based on the trajectory according to the type of the target selection operation includes:

acquiring and displaying the result by executing, based on the trajectory according to the type of the target selection operation, the corresponding image editing operation on the original image.

Optionally, the different trajectory display modes include at least one of the following: different display colors, different lines for display, or different text labels for display.

In a second aspect, the present disclosure provides a non-transitory computer-readable storage medium. The non-transitory computer-readable storage medium stores at least one computer program. The at least one computer program, when run by a processor, causes the processor to perform the above method.

In a third aspect, the present disclosure provides an electronic device including a memory and a processor. The memory stores at least one computer program. The processor, when running the at least one computer program, is caused to perform the above method.

### BRIEF DESCRIPTION OF THE DRAWINGS

FIG. 1 shows a flowchart of a method for editing an image according to an embodiment of the present disclosure;

FIG. 2 shows a flowchart of a method for editing an image according to another embodiment of the present disclosure;

FIG. 3 shows a schematic diagram of a display interface involved in a method for editing an image according to an embodiment of the present disclosure;

FIG. 4 shows an effect schematic diagram of a third canvas according to an embodiment of the present disclosure;

FIG. 5 shows a schematic structural diagram of an apparatus for editing an image according to an embodiment of the present disclosure;

FIG. 6 shows a schematic structural diagram of an apparatus for editing an image according to another embodiment of the present disclosure; and

FIG. 7 shows a schematic diagram of an electronic device according to an embodiment of the present disclosure.

### DETAILED DESCRIPTION

The following describes implementations of the present disclosure in detail in combination with the accompanying drawings and embodiments, so as to fully understand and accordingly implement a realizing process of how the present disclosure applies technical means to solve technical problems and achieve technical effects. It should be noted that, as long as there is no conflict, various features in the present disclosure may be combined with each other, and the formed technical solutions are all within a protection scope of the present disclosure.

Generally, when an original image is subjected to reserving and removing editing at the same time, the following steps need to be executed: firstly, selecting a reserved area on the original image, performing, by a background server, first processing according to the reserved area, and then selecting a removed area on the image after being processed for the first time, and performing, by the background server, second processing according to the removed area.

In an editing process, since an electronic device displaying the original image cannot effectively display a trajectory of an editing operation, a user cannot accurately determine whether own operation meets own editing intention.

Moreover, in the editing process, if the original image is subjected to reserving and removing editing, the user needs to perform at least two operations, and the server needs to run twice to acquire a target image. As a result, the image editing process is complicated and time-consuming, resulting in a low image editing efficiency.

In addition, a browser plug-in such as flash may be configured to edit the image for example, after the browser plug-in is installed, the user may use the browser plug-in to draw a new graphic or image on the original image. However, the manner of using the browser plug-in to edit the image requires the user to install the corresponding browser plug-in on a client side, which brings inconvenience to operation of the user, and the manner is insufficient in flexibility in aspect of programming operation.

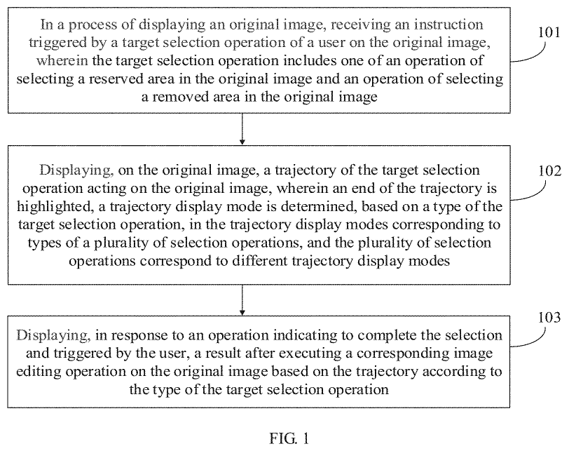

An embodiment of the present disclosure provides a method for editing an image. Referring to FIG. 1, the method for editing an image according to the embodiment of the present disclosure includes the following steps.

In step 101: in a process of displaying an original image; an instruction triggered by a target selection operation of the user on the original image is received, and the target selection operation includes one of an operation of selecting a reserved area in the original image and an operation of selecting a removed area in the original image.

In step 102: a trajectory of the target selection operation acting on the original image is displayed on the original image, an end of the trajectory is highlighted in the trajectory, a trajectory display mode is determined, based on a type of the target selection operation, in the trajectory display modes corresponding to types of a plurality of selection operations, and the trajectory display modes corresponding to the types of the plurality of selection operations are different.

Corresponding to a one-time selection operation of the user, the electronic de displays one trajectory on the original image. In addition, one trajectory or a plurality of trajectories may form a circle, and each circle formed by the selection operation is configured to indicate one of the selected area and the removed area.

In step 103: in response to an operation indicating to complete the selection and triggered by the user, a result after executing a corresponding image editing operation on the original image is displayed based on the trajectory according to the type of the target selection operation.

In the method for editing an image according to the embodiment of the present disclosure, the trajectories of different types of selection operations are displayed by different display modes on the original image according to the target selection operation of the user on the original image, and the end of the trajectory is highlighted in the trajectory. In this way, an operation process of the user can be visually displayed. In real time, which prompts the operation of the user and guides the user to determine whether own operation meets own editing intention according to the displayed trajectory, so as to correct errors in time.

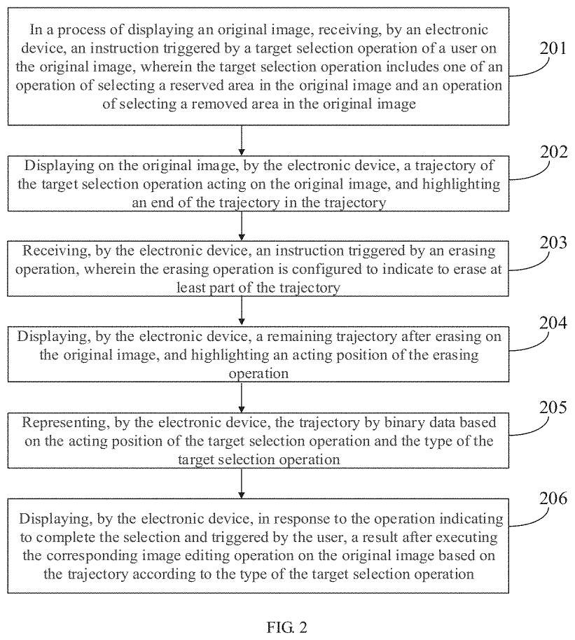

The following takes a case that the method for editing an image is applied to an electronic device as an example to illustrate an implementation process of the method for editing an image. As shown in FIG. 2, the method includes:

In step 201: in a process of displaying an original image, the electronic device receives an instruction triggered by a target selection operation of a user on the original image. The target selection operation includes one of an operation of selecting a reserved area in the original image and an operation of selecting a removed area in the original image.

In a process of viewing the image on the electronic device (for example, an application or web page of the electronic device), the user may perform a selection operation on the image and select content in the image to indicate the electronic device to edit the selected content. The selection operation may include at least one of the operation of selecting the reserved area in the image (for easy distinction, the edited image is referred to as the original image hereinafter), and the operation of selecting the removed area in the original image. In addition, the target selection operation executed by the user each time may include one of the operation of selecting the reserved area and the operation of selecting the removed area.

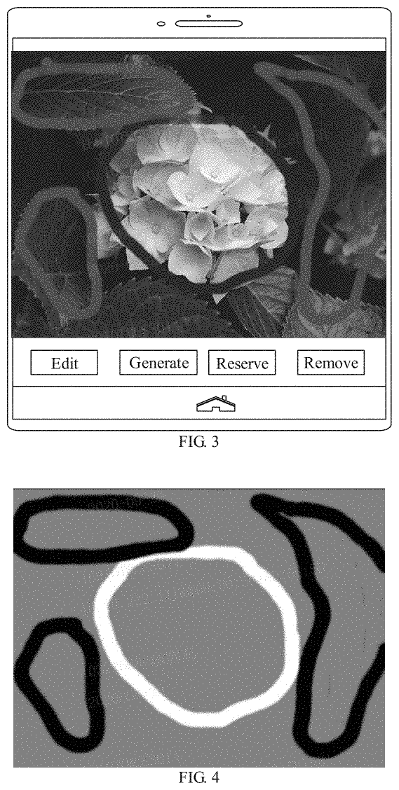

In an implementable manner, as shown in FIG. 3, a “reserve” button and a “remove” button are disposed in a display interface of the electronic device displaying the original image. When needing to select an area to be reserved from the original image, the user may firstly click the “reserve” button, and then use a contact medium such as a mouse, stylus, or finger to slide on a display screen of the electronic device to acquire the target selection operation for indicating to select the reserved area on the original image. Similarly, when needing to select an area to the removed from the original image, the user may firstly click the “remove” button, and then use the contact medium such as the mouse, stylus, or finger to slide on the display screen of the electronic device to acquire the target selection operation for indicating to select the removed area on the original image. When the contact medium such as the mouse, stylus, or finger is configured to slide on the display screen of the electronic device, the electronic device also needs to process events related to the contact medium, such as pressing, moving and lifting events of the mouse, to detect the target selection operation triggered by the contact medium.

In step 202: the electronic device displays, on the original image, a trajectory of the target selection operation acting on the original image, and an end of the trajectory is highlighted in the trajectory.

After receiving the instruction triggered by the target selection operation of the user on the original image, the electronic device may determine an acting position of the target selection operation, display, on the original image, the trajectory of the target selection operation acting on the original image, and highlight the end of the trajectory, such that the user can judge whether own operation meets own original intention according to the displayed trajectory, so as to correct errors in time. For example, as shown in FIG. 3, FIG. 3 shows a plurality of trajectories acquired by the electronic device according to a plurality of target selection operations of the user. According to the plurality of trajectories, one reserved area and three removed areas are acquired respectively. The reserved area is configured to indicate to reserve an area where a main body of a flower in the original image is disposed. The three removed areas are configured to indicate areas where leaves and the like in the original image are disposed. According to the reserved area and removed areas, it can be known that when editing the image, the area where the flower is disposed in the original image needs to be reserved, and the areas where the leaves and the like are disposed in the original image need to be removed. In a case that the contact medium such as mouse, stylus, or finger is configured to slide on the display screen of the electronic device, the end of the trajectory is a real-time position of the contact medium acting on the display screen.

Optionally, the electronic device may generate a virtual canvas and display the trajectory of the target selection operation on the canvas. At this point, an implementation process of displaying, on the original image, the trajectory of the target selection operation acting on the original image may include: setting pixels for indicating the trajectory on the canvas to be non-transparently displayed, wherein when the canvas is not configured to display the trajectory, the pixels in the canvas are all transparently displayed.

For example, when implementing a display process in step 202 with a canvas technology, the canvas generated by the electronic device may include a first canvas (also referred to as a display canvas) and a second canvas (also referred to as a drawing canvas) which are sequentially laminated and displayed on an upper layer of the original image. When the first canvas and the second canvas are not configured to display, pixels in the first canvas and pixels in the second canvas are both transparently displayed. Then the electronic device may display the end of the trajectory in the first canvas by setting the pixels for indicating the end of the trajectory in the first canvas to be non-transparently displayed, so as to acquire an effect of highlighting the end of the trajectory on the original image. Besides, the electronic device may display the trajectory in the second canvas by setting the pixels for indicating the trajectory in the second canvas to be non-transparently displayed, so as to acquire an effect of displaying the trajectory on the original image. The pixels in the first canvas are in one-to-one correspondence with the pixels in the original image, and the pixels in the second canvas are in one-to-one correspondence with the pixels in the original image, in addition, the electronic device may also display the end of the trajectory and the trajectory in different display modes, so as to acquire the display effect of highlighting the end of the trajectory.

Correspondingly, before displaying, on the original image, the trajectory of the target selection operation acting on the original image, the method further includes: generating the canvas. The pixels in the canvas are in one-to-one correspondence with the pixels in the original image, and an initial state of the canvas is that the canvas is transparently displayed on the upper layer of the original image. When the pixels in the canvas are in one-to-one correspondence with the pixels in the original image, it can be ensured that the position indicated by the trajectory when the trajectory is displayed in the canvas is the same as the acting position of the target selection operation of the user on the original image. The electronic device may draw a graphic through JavaScript and HTML <canvas> elements to achieve the effect of generating the canvas.

Moreover, the operation of generating the canvas may be triggered by a specified operation. In an implementable manner, when needing to edit the original image, the user may trigger an instruction indicating to edit the original image, and after receiving the instruction, the electronic device may be triggered by the instruction to generate the canvas. For example, as shown in FIG. 3, an “edit” button is displayed in the display interface of the electronic device. After the user clicks the “edit” button, the instruction of editing the original image may be triggered. After the electronic device receives the instruction indicating to edit the original image, the electronic device may also display the “reserve” and “remove” buttons on the display interface based on the instruction for the user to execute the operation of selecting the reserved area or the operation of selecting the removed area. Alternatively, the operation of generating the canvas may also be executed after the electronic device receives an instruction triggered by the target selection operation executed by the user for the first time in the current image editing operation process, which is not specifically limited in the embodiment of the present disclosure.

In an optional implementation, a trajectory display mode may be determined, based on the type of the target selection operation, in the trajectory display modes corresponding to types of a plurality of selection operations, and various types of selection operations correspond to different trajectory display modes. The type of the selection operation is configured to indicate the type of an area selected by the selection operation. For example, different types of selection operations may include: a selection operation for indicating the selection of the reserved area and a selection operation for indicating the selection of the removed area.

Optionally, different display modes include at least one of the following: different display colors, different lines for display, and different text labels for display, etc. For example, the electronic device may use a blue color to display the trajectory of the selection operation of selecting the reserved area acting on the original image, use a prominent blue dot to highlight the end of the trajectory, and use a red color to display the trajectory the selection operation of selecting the removed area acting on the original image and use a prominent red dot to highlight the end of the trajectory.

In step 203: the electronic device receives an instruction triggered by an erasing operation, wherein the erasing operation is configured to indicate to erase at least part of the trajectory.

After the user executes the target selection operation, if it is determined that the selected area according to the displayed trajectory does not meet own editing intention, the user may perform the erasing operation on the displayed trajectory to erase the trajectory that does not meet the editing intention of the user. After the user executes the erasing operation, the electronic device may receive the instruction triggered by the erasing operation. In addition, the user may erase part or all of the displayed trajectory based on own editing intention. By providing the erasing function, the user may cancel the selected area according to the editing intention, which can simplify an editing process of the image and improve the image editing efficiency.

In step 204: the electronic device displays a remaining trajectory after erasing on the original image, and highlights an acting position of the erasing operation.

After receiving the instruction triggered by the erasing operation, the electronic device may acquire the acting position of the erasing operation, and display the remaining trajectory after erasing according to the acting position. In addition, the electronic device may also highlight the acting position of the current erasing operation, such that the user can know a real-time acting position of the erasing operation, and accordingly judge whether the current operation meets the editing intention of the user, so as to correct errors in time.

Optionally, the electronic device may also display an erased trajectory. In addition, in order to facilitate the distinction, the display mode of the remaining trajectory after erasing is different from the erased trajectory. For example, when the electronic device uses the blue color to display the trajectory of the selection operation of selecting the reserved area acting on the original image, and uses the red color to display the trajectory of the selection operation of selecting the removed area acting on the original image, a yellow color may be adopted to indicate the erased trajectory. In addition, the erasing operation may indicate to erase part or all of the trajectory. When the erasing operation indicates to erase all of the trajectory displayed by the electronic device, no trajectory remains, and the electronic device may not execute the operation of displaying the remaining trajectory.

According to the previous description, it can be known that when the electronic device displays the trajectory through the canvas, the upper layer of the original image displays the first canvas and the second canvas, and then an effect of highlighting the end of the trajectory and the acting position of the erasing operation on the original image may be acquired by displaying the end of the trajectory and the acting position of the erasing operation in the first canvas. The effect of displaying the trajectory, the remaining trajectory after erasing, and the erased trajectory on the original image is acquired by displaying the trajectory, the remaining trajectory after erasing and the erased trajectory in the second canvas.

It should be noted that in the one-time process of editing the image, the user may execute one or more selection operations on the original image, and may execute one or more erasing operations. Then for the selection operation and the erasing operation executed by the user each time, the electronic device may execute the corresponding processing as described above. The one-time process of editing the image refers to a process from the start of executing the editing operation on the image by the user to the display of an editing result by the electronic device according to the editing operation.

Moreover, when the canvas technology is adapted, in order to ensure effective implementation of the target selection operation, some settings further need to be executed. For example, the setting of a global composite operation attribute for a context object in the canvas. In addition, when the reserving and removing operations are executed, a value of the global composite operation attribute needs to be set to “source-over”, which indicates that a new graphic drawn afterwards will cover an original content for display, such that the trajectories for selecting the reserved area and the removed area cover the original image for display. When the erasing operation is executed, the value of the global composite operation attribute needs to be set to “destination-out”, such that part of the original content that does not overlap with the new graphic is reserved.

In step 205: the electronic device represents the trajectory by binary data based on the acting position of the target selection operation and the type of the target selection operation.

Representing the trajectory by the binary data refers to representing the acting position and type of the target selection operation that forms the trajectory by the binary data. For example, the binary data is adopted to indicate the acting position of the target selection operation, and whether the area selected by the target selection operation is the reserved area or removed area. The type of the binary data may be determined according to application requirements, for example, the binary data may be an ArrayBuffer type.

When the electronic device displays the trajectory through the canvas, the canvas generated by the electronic device also includes a third canvas (also referred to as a recording canvas), positions of pixels in the third canvas are in one-to-one correspondence with the positions of the pixels in the original image, and the third canvas may be configured to realize a binary representation of the trajectory. For example, based on the acting position of the target selection operation and the type of the target selection operation, representing the trajectory by the binary data includes: setting a pixel value of the pixels for representing the trajectory indicating the reserved area in the third canvas to be one of 0 and 1, and setting a pixel value of the pixels for representing the trajectory indicating the removed area in the third canvas to the other of 0 and 1. In addition, the third canvas may be regarded as a carrying main body of a data conversion result representing the trajectory, and is mainly configured to transfer parameters to the background, and then the third canvas may not be displayed in the electronic device to ensure a display effect of the image displayed by the electronic device. Alternatively, the third canvas may also be superimposed and displayed on the upper layer of the original image, and in order to avoid an impact on the display effect of the image displayed by the electronic device, the electronic device may display the third canvas transparently. For example, from top to bottom in the electronic device, the first canvas, the second canvas, the third canvas and the original image may be respectively displayed in layers.

In addition, the third canvas may be a three-color canvas, that is, there are only three pixel values of the pixels in the third canvas, wherein the pixel values 0 and 1 are configured to indicate the reserved area and the removed area, and the pixel value in the three pixel values other than 0 and 1 is configured to represent a background of the third canvas. For example, the pixels in the third canvas include the pixels with pixel values 0 and 1, and gray pixels. The gray pixels have a pixel value between 0 and 1, for example, the gray pixels have a pixel value of 0.5. As shown in FIG. 4, in the third canvas, the pixels with the pixel value 0 are adopted to represent the removed area, the pixels with the pixel value 1 are adopted to represent the reserved area, and the gray pixels are adopted to represent a background area of the third canvas. In this way, a language recognizable by a computer is usually a language represented by 0 and 1. Therefore, 0 and 1 are adopted to represent the reserved area and the removed area, thereby saving the time of image editing according to a display content of the third canvas, and improve the efficiency of executing the image editing operation on the original image according to the target selection operation.

Optionally, an executing timing of this step 205 may be determined according to application requirements. For example, the electronic device may represent the trajectory by the binary data based on the currently received acting position and type of the target selection operation immediately after receiving the instruction triggered by the target selection operation every time. For another example, after completing the selection operation in the one-time process of editing the original image, the user may trigger an operation indicating to complete the selection. Besides, the electronic device may, in response to the operation indicating to complete the selection and triggered by the user, represent all corresponding trajectories by the binary data based on the acting positions and types of all target selection operations received in the process. In an implementable manner, a “generate” button is displayed on the display interface displaying the original image. After completing all the selection operations in the one-time process of editing the original image, the user may click the “generate” button to trigger the operation indicating to complete the selection.

After receiving the instruction triggered by the target selection operation each time, the electronic device immediately represents the trajectory by the binary data, such that the process of representing the trajectory by the binary data can be executed synchronously in the process of editing the original image by the user. Thus, after the entire process of editing the original image is completed, the image can be edited according to the trajectory represented by the binary data, which can reduce the time consumed for waiting the binary data to represent the trajectory, and improve the image editing efficiency.

It should be noted that representing the trajectory by the binary data is actually representing the trajectory in a language recognizable by an execution body for executing the editing operation on the original image. In the embodiment of the present disclosure, other languages may also be adopted to represent the trajectory, for example, a base64 character string is adopted to represent the trajectory. The binary data for representation is only an example of an implementation manner, without limiting the representation manner.

In step 206: in response to the operation indicating to complete the selection and triggered by the user, the electronic device displays a result after executing the corresponding image editing operation on the original image based on the trajectory according to the type of the target selection operation.

An implementation process of step 206 is different according to different executing main bodies executing the corresponding image editing operation on the original image. The following two implementable manners are taken as examples for illustration.

In a first implementable manner, when the execution body executing the corresponding image editing operation on the original image is a server providing a service for the electronic device, the implementation process of step 206 includes: sending, by the electronic device, the trajectory and the original image to the server, then receiving the result after executing the corresponding image editing operation on the original image by the server based on the trajectory according to the type of the target selection operation, and displaying the result.

When the binary data is adopted to represent the trajectory, the trajectory sent by the electronic device to the server is represented by the binary data, and then the server may acquire the result after executing the corresponding image editing operation on the original image based on the trajectory represented by the binary data according to the type of the target selection operation, and display the result. Executing the corresponding image editing operation on the original image refers to: recognizing a selected target object in the reserved area and/or removed area on the original image by an image recognition algorithm (for example, an artificial intelligence algorithm), reserving a range covered by the reserved area in the original image when the target selection operation selects the reserved area, and removing a range covered by the removed area in the original image when the target selection operation selects the removed area. In addition, when the original image is stored in the server, the electronic device may not send the original image to the server, but send instruction information of the original image to the server, such that the server can acquire the original image to be edited.

Moreover, in the embodiment of the present disclosure, the trajectories acquired by all the selection operations in the one-time process of editing the original image may be sent to the server at one step, such that the server can process the original image at one step according to all image editing operations of the user, thereby simplifying the image editing operation flow, saving time for the image editing operation, and improve the image editing efficiency.

In a second implementable manner, when the execution body executing the corresponding image editing operation on the original image is the electronic device per se, the implementation process of step 206 includes: acquiring and displaying the result 1w executing, based on the trajectory according to the type of the target selection operation, the corresponding image editing operation on the original image.

When the binary data is adopted to represent the trajectory, the electronic device may display the result after executing the corresponding image editing operation on the original image based on the trajectory represented by the binary data according to the type of the target selection operation represented by the trajectory, and display the result. In addition, the electronic device may also process the original image at one step according to the trajectories acquired from all the selection operations in the one-time process of editing the original image, so as to simplify the image editing operation flow, save time for the image editing operation, and improve the image editing efficiency.

In summary, in the method for editing an image according to the embodiment of the present disclosure, the trajectories of different types of selection operations are displayed by different display modes on the original image according to the target selection operation of the user on the original image, and the end of the trajectory is highlighted in the trajectory. In this way, an operation process of the user can be visually displayed in real time, which prompts the operation of the user and guide the user to determine whether own operation meets own editing intention according to the displayed trajectory, so as to correct errors in time.

Moreover, in the method, the user only needs to simply delineate the reserved area and the removed area in the original image, then the target object in the reserved area or in the removed area can be accurately cut out, and the original image can be intelligently cut out, which reduces an image editing difficulty of the user and improves user experience. In addition, with the canvas technology, various graphics can be easily drawn on a web page, an interaction process of the user can be visually displayed, and operation data can be transferred to the server for processing, thereby providing a great convenience for image processing on a web side.

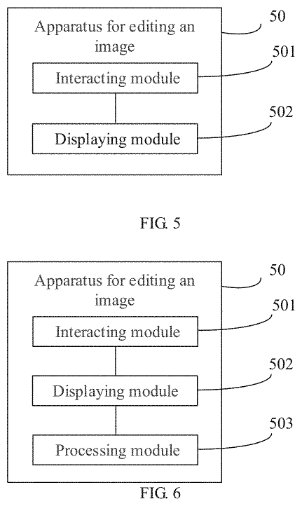

An embodiment of the present disclosure also provides an apparatus for editing an image. As shown in FIG. 5, the apparatus for editing an image 50 includes:

an interacting module 501 configured to receive, in a process of displaying an original image, an instruction triggered by a target selection operation of a user on the original image, wherein the target selection operation includes one of an operation of selecting a reserved area in the original image and an operation of selecting a removed area in the original image; and

a displaying module 502 configured to display a trajectory, on the original image, of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes.

The displaying module 502 is configured to display, in response to an operation indicating to complete the selection and triggered by the user, a result after executing a corresponding image editing operation on the original image based on the trajectory according to the type of the target selection operation.

Optionally, the interacting module 501 is further configured to receive an instruction indicating to edit the original image.

As shown in FIG. 6, the apparatus 50 further includes a processing module 503 configured to generate a canvas based on the instruction indicating to edit the original image, wherein the canvas is transparently displayed on an upper layer of the original image, and pixels in the canvas are in one-to-one correspondence with pixels in the original image.

The displaying module 502 is specifically configured to set the pixels for indicating the trajectory on the canvas to be non-transparently displayed.

Optionally, the canvas includes a first canvas and a second canvas which are sequentially laminated and displayed on the upper layer of the original image. The displaying module 502 is configured to, acquire an effect of highlighting the end of the trajectory on the original image by displaying the end of the trajectory in the first canvas. The displaying module 502 is configured to, acquire an effect of displaying the trajectory on the original image by displaying the trajectory in the second canvas.

Optionally, the interacting module 501 is further configured to receive an instruction triggered by an erasing operation, wherein the erasing operation is configured to indicate to erase at least part of the trajectory.

The displaying module 502 is further configured to display a remaining trajectory after erasing on the original image, and highlight an acting position of the erasing operation.

Optionally, the displaying module 502 is further configured to display an erased trajectory, wherein the remaining trajectory and the erased trajectory have different display modes.

Optionally, the first canvas and the second canvas are displayed on the upper layer of the original image, pixels in the first canvas are in one-to-one correspondence with the pixels in the original image, and pixels in the second canvas are in one-to-one correspondence with the pixels in the original image.

The displaying module 502 is configured to acquire an effect of highlighting the end of the trajectory and the acting position of the erasing operation on the original image by displaying the end of the trajectory and the acting position of the erasing operation in the first canvas.

The displaying module 502 is configured to acquire an effect of displaying the trajectory, the remaining trajectory and the erased trajectory on the original image by displaying the trajectory, the remaining trajectory, and the erased trajectory in the second canvas.

Optionally, the processing module 503 is configured to represent, based on an acting position of the target selection operation and the type of the target selection operation, the trajectory by binary data.

Correspondingly, the displaying module 502 is specifically configured to display, in response to the operation indicating to complete the selection and triggered by the user, the result after executing the corresponding image editing operation on the original image based on the trajectory represented by the binary data according to the type of the target selection operation.

Optionally, the processing module 503 is specifically configured to set a pixel value of pixels for representing the trajectory indicating the reserved area in a third canvas to one of 0 and 1, and set a pixel value of pixels for representing the trajectory indicating the removed area in the third canvas to the other of 0 and 1, wherein positions of the pixels in the third canvas are in one-to-one correspondence with positions of the pixels in the original image.

Optionally, the processing module 503 is configured to represent, in response to the operation indicating to complete the selection and triggered by the user, the trajectory by binary data based on an acting position of the target selection operation and the type of the target selection operation.

Correspondingly, the displaying module 502 is specifically configured to display, in response to the operation indicating to complete the selection and triggered by the user, the result after executing the corresponding image editing operation on the original image based on the trajectory represented by the binary data according to the type of the target selection operation.

Optionally, the interacting module 501 is further configured to send the trajectory and the original image to a server; and receive the result after executing the corresponding image editing operation on the original image by the server based on the trajectory according to the type of the target selection operation.

Optionally, the processing module 503 is configured to acquire the result by executing, based on the trajectory according to the type of the target selection operation, the corresponding image editing operation on the original image.

Optionally, the different trajectory display modes include at least one of the following: different display colors, different lines for display, or different text labels for display.

In summary, in the apparatus for editing an image according to the embodiment of the present disclosure, the trajectories of different types of selection operations are displayed by different display modes on the original image according to the target selection operation of the user on the original image, and the end of the trajectory is highlighted in the trajectory. In this way, an operation process of the user can be visually displayed in real time, which prompts the operation of the user and guide the user to determine whether own operation meets own editing intention according to the displayed trajectory, so as to correct errors in time.

Moreover, in the apparatus, the user only needs to simply delineate the reserved area and the removed area in the original image, then a target object in the reserved area or in the removed area can be accurately cut out, and the original image can be intelligently cut out, which reduces an image editing difficulty of the user and improves user experience. In addition, with the canvas technology, various graphics can be easily drawn on a web page, an interaction process of the user can be visually displayed, and operation data can be transferred to the server for processing, thereby providing a great convenience for image processing on a web side.

An embodiment of the present disclosure further provides a storage medium. The storage medium may be a non-transitory computer-readable storage medium. At least one computer program is stored on the storage medium. The at least one computer program, when run by a processor, causes the processor to perform the method for editing an image in the foregoing embodiment.

Beneficial effects of the storage medium according to the embodiment of the present disclosure are the same as those of the above method for editing an image, and will not be repeated here.

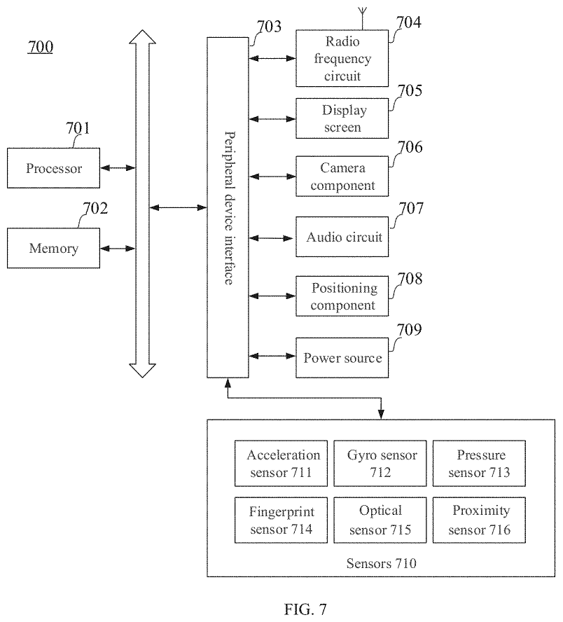

An embodiment of the present disclosure also provides an electronic device. The electronic device includes a memory and a processor. At least one computer program is stored on the memory. The processor, when running the at least one computer program, is caused to perform the method for editing an image in the foregoing embodiment. FIG. 7 is a schematic structural diagram of an electronic device according to an embodiment of the present disclosure. As shown in FIG. 7, the electronic device 700 includes a processor 701 and a memory 702.

The processor 701 may include one or more processing cores, such as a 4-core processor and an 8-core processor, Besides, the processor 701 may be one processor or a collective term of a plurality of processing elements. The processor 701 may be formed by at least one hardware of a digital signal processing (DSP), afield-programmable gate array (FPGA), and a programmable logic array (PIA), and may also be an application specific integrated circuit (ASIC), or one or more integrated circuits configured to implement the embodiments of the present disclosure. The processor 701 may also include a main processor and a coprocessor. The main processor is a processor for processing the data in an awake state, and is also called a central processing unit (CPU). The coprocessor is a low-power-consumption processor for processing the data in a standby state. In some embodiments, the processor 701 may be integrated with a graphics processing unit (GPU), which is configured to render and draw the content that needs to be displayed by a display screen. In some embodiments, the processor 701 may also include an artificial intelligence (AI) processor configured to process computational operations related to machine learning.

The memory 702 may include one or more computer-readable storage mediums, which may be non-transitory. The memory 702 may also include a high-speed random access memory, as well as a non-volatile memory, such as one or more disk storage devices and flash storage devices. For example, the memory 702 may include a random access memory (RAM), or may include a non-volatile memory, such as a magnetic disk memory and a flash memory (Flash).

In some embodiments, the non-transitory computer-readable storage medium in the memory 702 is configured to store at least one instruction. The at least one instruction is configured to be run by the processor 701 to cause the processor 701 to perform the method for editing an image according to the method embodiments of the present disclosure. For example, the instruction stored on the memory, when run by the processor, causes the processor to perform: receiving, in a process of displaying an original image, an instruction triggered by a target selection operation of a user on the original image, wherein the target selection operation includes one of an operation of selecting a reserved area in the original image and an operation of selecting a removed area in the original image; displaying, on the original image, a trajectory of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes; and displaying, in response to an operation indicating to complete the selection and triggered by the user, a result after executing a corresponding image editing operation on the original image based on the trajectory according to the type of the target selection operation.

Optionally, the processor, when running the at least one computer program, is caused to perform: receiving an instruction indicating to edit the original image; and generating a canvas based on the instruction indicating to edit the original image, wherein the canvas is transparently displayed on an upper layer of the original image, and pixels in the canvas are in one-to-one correspondence with pixels in the original image; and correspondingly, displaying, on the original image, the trajectory of the target selection operation acting on the original image includes: setting the pixels for indicating the trajectory on the canvas to be non-transparently displayed.

Optionally, the canvas includes a first canvas and a second canvas which are sequentially laminated and displayed on the upper layer of the original image; an effect of highlighting the end of the trajectory on the original image is acquired by displaying the end of the trajectory in the first canvas; and an effect of displaying the trajectory on the original image is acquired by displaying the trajectory in the second canvas.

Optionally, the processor, when running the at least one computer program, is caused to perform: receiving an instruction triggered by an erasing operation, wherein the erasing operation is configured to indicate to erase at least part of the trajectory; and displaying a remaining trajectory after erasing on the original image, and highlighting an acting position of the erasing operation.

Optionally, after receiving the instruction triggered by the erasing operation, the method further includes: displaying an erased trajectory, wherein the remaining trajectory and the erased trajectory have different display modes.

Optionally, the first canvas and the second canvas are displayed on the upper layer of the original image, pixels in the first canvas are in one-to-one correspondence with the pixels in the original image, and pixels in the second canvas are in one-to-one correspondence with the pixels in the original image; an effect of highlighting the end of the trajectory and the acting position of the erasing operation on the original image is acquired by displaying the end of the trajectory and the acting position of the erasing operation in the first canvas; and an effect of displaying the trajectory, the remaining trajectory and the erased trajectory on the original image is acquired by displaying the trajectory, the remaining trajectory, and the erased trajectory in the second canvas.

Optionally, the processor, when running the at least one computer program, is caused to perform: representing, based on an acting position of the target selection operation and the type of the target selection operation, the trajectory by binary data; and displaying, in response to the operation indicating to complete the selection and triggered by the user, the result after executing the corresponding image editing operation on the original image based on the trajectory represented by the binary data according to the type of the target selection operation.

Optionally, representing, based on the acting position of the target selection operation and the type of the target selection operation, the trajectory by the binary data includes: setting a pixel value of pixels for representing the trajectory indicating the reserved area in a third canvas to one of 0 and 1, and setting a pixel value of pixels for representing the trajectory indicating the removed area in the third canvas to the other of 0 and 1, wherein positions of the pixels in the third canvas are in one-to-one correspondence with positions of the pixels in the original image.

Optionally, the processor, when running the at least one computer program, is caused to perform: representing, in response to the operation indicating to complete the selection and triggered by the user, the trajectory by binary data based on an acting position of the target selection operation and the type of the target selection operation; and displaying, in response to the operation indicating to complete the selection and triggered by the user, the result after executing the corresponding image editing operation on the original image based on the trajectory represented by the binary data according to the type of the target selection operation.

Optionally, the processor, when running the at least one computer program, is caused to perform: sending the trajectory and the original image to a server; receiving the result after executing the corresponding image editing operation on the original image by the server based on the trajectory according to the type of the target selection operation; and displaying the result.

Optionally, the processor, when running the at least one computer program, is caused to perform: acquiring and displaying the result by executing, based on the trajectory according to the type of the target selection operation, the corresponding image editing operation on the original image.

Optionally, the different trajectory display modes include at least one of the following: different display colors, different lines for display, or different text labels for display.

In some embodiments, the electronic device 700 also optionally includes a peripheral device interface 703 and at least one peripheral device. The processor 701, the memory 702, and the peripheral device interface 703 may be connected by a bus or a signal line. Each peripheral device may be connected to the peripheral device interface 703 by a bus, a signal line or a circuit board. Specifically, the peripheral device includes at least one of a radio frequency circuit 704, a display screen 705, a camera component 706, an audio circuit 707, a positioning component 708, and a power source 709.

The peripheral device interface 703 may be configured to connect at least one peripheral device associated with an input/output (I/O) to the processor 701 and the memory 702. In some embodiments, the processor 701, the memory 702, and the peripheral device interface 703 are integrated on the same chip or circuit board. In some other embodiments, any one or two of the processor 701, the memory 702, and the peripheral device interface 703 may be implemented on a separate chip or circuit board, which is not limited in the embodiment of the present disclosure.

The radio frequency circuit 704 is configured to receive and transmit a radio frequency (RF) signal, which is also referred to as an electromagnetic signal. The radio frequency circuit 704 communicates with a communication network and other communication devices via the electromagnetic signal. The radio frequency circuit 704 converts the electrical signal into the electromagnetic signal for transmission, or converts the received electromagnetic signal into the electrical signal. Optionally, the radio frequency circuit 704 includes an antenna system, an RF transceiver, one or more amplifiers, a tuner, an oscillator, a digital signal processor, a codec chipset, a subscriber identity module card, and the like. The radio frequency circuit 704 may communicate with other terminals via at least one wireless communication protocol. The wireless communication protocol includes, but not limited to, the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 704 may also include near field communication (NFC) related circuits, which is not limited in the present disclosure.

The display screen 705 is configured to display a user interface (UI). The UI may include graphics, text, icons, videos, and any combination thereof. When the display screen 705 is a touch display screen, the display screen 705 also has the capacity to acquire touch signals on or over the surface of the display screen 705. The touch signal may be input into the processor 701 as a control signal for processing. At this time, the display screen 705 may also be configured to provide virtual buttons and/or virtual keyboards, which are also referred to as soft buttons and/or soft keyboards. In some embodiments, one display screen 705 may be disposed on the front panel of the electronic device 700. In some other embodiments, at least two display screens 705 may be disposed respectively on different surfaces of the electronic device 700 or in a folded design. In further embodiments, the display screen 705 may be a flexible display screen disposed on the curved or folded surface of the electronic device 700. Even the display screen 705 may also be set in an irregular shape other than a rectangle, that is, an irregular-shaped screen. The display screen 705 may be a liquid crystal display (LCD) screen or an organic light-emitting diode (OLED) display screen.

The camera component 706 is configured to capture images or videos. Optionally, the camera component 706 includes a front camera and a rear camera, Usually, the front camera is disposed on the front panel of the terminal, and the rear camera is disposed on the back of the terminal. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and virtual reality (VR) shooting functions achieved by fusion of the main camera and the wide-angle camera or other fusion shooting functions. In some embodiments, the camera component 706 may also include a flashlight. The flashlight may be a mono-color temperature flashlight or a two-color temperature flashlight. The two-color temperature flash is a combination of a warm flashlight and a cold flashlight and can be configured for light compensation at different color temperatures.

The audio circuit 707 may include a microphone and a speaker. The microphone is configured to collect sound waves of users and environments, and convert the sound waves into electrical signals which are input into the processor 701 for processing, or input into the RF circuit 704 for voice communication. For the purpose of stereo acquisition or noise reduction, there may be a plurality of microphones respectively disposed at different locations of the electronic device 700. The microphone may also be an array microphone or an omnidirectional acquisition microphone. The speaker is then configured to convert the electrical signals from the processor 701 or the radio frequency circuit 704 into the sound waves. The speaker may be a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 707 may also include a headphone jack.

The positioning component 708 is configured to locate the current geographic location of the electronic device 700 to implement navigation or location based service (LBS). The positioning component 708 may be the United States' Global Positioning System (GPS), Russia's Global Navigation Satellite System (GLONASS), China's BeiDou Navigation Satellite System (BDS), and the European Union's Galileo.

The power source 709 is configured to power up various components in the electronic device 70. The power source 709 may be alternating current, direct current, a disposable battery, or a rechargeable battery. When the power source 709 includes the rechargeable battery, the rechargeable battery may a wired rechargeable battery or a wireless rechargeable battery. The wired rechargeable battery is a battery charged by a cable line, and wireless rechargeable battery is charged by a wireless coil. The rechargeable battery may also support the fast charging technology.

In some embodiments, the electronic device 700 also includes one or more sensors 710. The one or more sensors 710 include, but not limited to, an acceleration sensor 711, a gyro sensor 712, a pressure sensor 713, a fingerprint sensor 714, an optical sensor 715, and a proximity sensor 716.

The acceleration sensor 711 may detect magnitudes of accelerations on three coordinate axes of a coordinate system established by the electronic device 700. For example, the acceleration sensor 711 may be configured to detect components of a gravitational acceleration on the three coordinate axes. The processor 701 may control the display screen 705 to display a user interface in a landscape view or a portrait view according to a gravity acceleration signal collected by the acceleration sensor 711. The acceleration sensor 711 may also be configured to collect motion data of a game or a user.

The gyro sensor 712 may detect a body direction and a rotation angle of the electronic device 700, and may cooperate with the acceleration sensor 711 to collect a 3D motion of the user on the electronic device 700. Based on the data collected by the gyro sensor 712, the processor 701 may serve the following functions: motion sensing (such as changing the UI according to a user's tilt operation), image stabilization during shooting, game control, and inertial navigation.

The pressure sensor 713 may be disposed on a side frame of the electronic device 70 and/or a lower layer of the display screen 705, When the pressure sensor 713 is disposed on the side frame of the electronic device 700, a user's holding signal to the electronic device 700 may be detected. The processor 701 can perform left-right hand recognition or quick operation according to the holding signal collected by the pressure sensor 713. When the pressure sensor 713 is disposed on the lower layer of the display screen 705, the processor 701 controls an operable control on the UI according to a user's pressure operation on the touch display screen 705. The operable control includes at least one of a button control, a scroll bar control, an icon control, and a menu control.

The fingerprint sensor 714 is configured to collect a user's fingerprint. The processor 701 identifies the user's identity based on the fingerprint collected by the fingerprint sensor 714, or the fingerprint sensor 714 identifies the user's identity based on the collected fingerprint. When the user's identity is identified as trusted, the processor 701 authorizes the user to perform related sensitive operations, such as unlocking the screen, viewing encrypted information, downloading software, paying, and changing settings. The fingerprint sensor 714 may be provided on the front, back, or side of the electronic device 700. When the electronic device 700 is provided with a physical button or a manufacturer's Logo, the fingerprint sensor 714 may be integrated with the physical button or the manufacturer's Logo.

The optical sensor 715 is configured to collect ambient light intensity. In one embodiment, the processor 701 may control the display brightness of the display screen 705 according to the ambient light intensity collected by the optical sensor 715. Specifically, when the ambient light intensity is high, the display brightness of the display screen 705 is increased; and when the ambient light intensity is low, the display brightness of the display screen 705 is decreased. In another embodiment, the processor 701 may also dynamically adjust shooting parameters of the camera component 706 according to the ambient light intensity collected by the optical sensor 715.

The proximity sensor 716, also referred to as a distance sensor, is usually disposed on the front panel of the electronic device 700. The proximity sensor 716 is configured to capture a distance between the user and a front surface of the electronic device 700. In one embodiment, when the proximity sensor 716 detects that the distance between the user and the front surface of the electronic device 700 becomes gradually smaller, the processor 701 controls the touch display screen 705 to switch from a screen-on state to a screen-off state. When it is detected that the distance between the user and the front surface of the electronic device 700 gradually increases, the processor 701 controls the touch display screen 705 to switch from the screen-off state to the screen-on state.

It will be understood by those skilled in the art that the structure shown in FIG. 7 does not constitute a limitation to the electronic device 700, and may include more or less components than those illustrated, or combine some components, or adopt different component arrangements.

Although the embodiments disclosed in the present disclosure are as described above, the content described is only the embodiments adopted to facilitate the understanding of the present disclosure, and is not intended to limit the present disclosure. Any person skilled in the art of the present disclosure can make any modifications and changes in implementation forms and details without departing from the spirit and scope disclosed by the present disclosure. However, the protection scope of the present disclosure still takes the scope defined by appended claims as a criterion.

What is claimed is:

1. A method for editing an image, comprising:
receiving, in a process of displaying an original image, an instruction triggered by a target selection operation of a user on the original image, wherein the target selection operation comprises one of an operation of selecting a reserved area in the original image and an operation of selecting a removed area in the original image;
displaying, on the original image, a trajectory of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes; and
displaying, in response to an operation indicating to complete the selection and triggered by the user, a result after executing a corresponding image editing operation on the original image based on the trajectory according to the type of the target selection operation.

2. The method according to claim 1, before receiving the instruction triggered by the target selection operation of the user on the original image, further comprises:
receiving an instruction indicating to edit the original image; and
generating a canvas based on the instruction indicating to edit the original image, wherein the canvas is transparently displayed on an upper layer of the original image, and pixels in the canvas are in one-to-one correspondence with pixels in the original image; and
displaying, on the original image, the trajectory of the target selection operation acting on the original image comprises:
setting the pixels for indicating the trajectory on the canvas to be non-transparently displayed.

3. The method according to claim 2, wherein the canvas comprises a first canvas and a second canvas which are sequentially laminated and displayed on the upper layer of the original image; wherein
an effect of highlighting the end of the trajectory on the original image is acquired by displaying the end of the trajectory in the first canvas; and
an effect of displaying the trajectory on the original image is acquired by displaying the trajectory in the second canvas.

4. The method according to claim 1, further comprising:
receiving an instruction triggered by an erasing operation, wherein the erasing operation is configured to indicate to erase at least part of the trajectory; and
displaying a remaining trajectory after erasing on the original image, and highlighting an acting position of the erasing operation.

5. The method according to claim 4, after receiving the instruction triggered by the erasing operation, further comprises:
displaying an erased trajectory, wherein the remaining trajectory and the erased trajectory have different display modes.

6. The method according to claim 5, wherein the first canvas and the second canvas are displayed on the upper layer of the original image, pixels in the first canvas are in one-to-one correspondence with the pixels in the original image, and pixels in the second canvas are in one-to-one correspondence with the pixels in the original image;
an effect of highlighting the end of the trajectory and the acting position of the erasing operation on the original image is acquired by displaying the end of the trajectory and the acting position of the erasing operation in the first canvas; and
an effect of displaying the trajectory, the remaining trajectory and the erased trajectory on the original image is acquired by displaying the trajectory, the remaining trajectory, and the erased trajectory in the second canvas.

7. The method according to claim 1, wherein after receiving the instruction triggered by the target selection operation of the user on the original image, the method further comprises:
representing, based on an acting position of the target selection operation and the type of the target selection operation, the trajectory by binary data; and
displaying, in response to the operation indicating to complete the selection and triggered by the user, the result after executing the corresponding image editing operation on the original image based on the trajectory according to the type of the target selection operation comprises:
displaying, in response to the operation indicating to complete the selection and triggered by the user, the result after executing the corresponding image editing operation on the original image based on the trajectory represented by the binary data according to the type of the target selection operation.

8. The method according to claim 7, wherein representing, based on the acting position of the target selection operation and the type of the target selection operation, the trajectory by the binary data comprises:
setting a pixel value of pixels for representing the trajectory indicating the reserved area in a third canvas to one of 0 and 1, and setting a pixel value of pixels for representing the trajectory indicating the removed area in the third canvas to the other of 0 and 1, wherein positions of the pixels in the third canvas are in one-to-one correspondence with positions of the pixels in the original image.

9. The method according to claim 1, wherein after displaying, on the original image, the trajectory of the target selection operation acting on the original image, the method further comprises:
representing, in response to the operation indicating to complete the selection and triggered by the user, the trajectory by binary data based on an acting position of the target selection operation and the type of the target selection operation; and
displaying, in response to the operation indicating to complete the selection and triggered by the user, the result after executing the corresponding image editing operation on the original image based on the trajectory according to the type of the target selection operation comprises:
displaying, in response to the operation indicating to complete the selection and triggered by the user, the result after executing the corresponding image editing operation on the original image based on the trajectory represented by the binary data according to the type of the target selection operation.

10. The method according to claim 1, wherein displaying the result after executing the corresponding image editing operation on the original image based on the trajectory according to the type of the target selection operation comprises:
sending the trajectory and the original image to a server;
receiving the result after executing the corresponding image editing operation on the original image by the server based on the trajectory according to the type of the target selection operation; and
displaying the result.

11. The method according to claim 1, wherein displaying the result after executing the corresponding image editing operation on the original image based on the trajectory according to the type of the target selection operation comprises:
acquiring and displaying the result by executing, based on the trajectory according to the type of the target selection operation, the corresponding image editing operation on the original image.

12. The method according to claim 1, wherein the different trajectory display modes comprise at least one of the following: different display colors, different lines for display, or different text labels for display.

13. An electronic device comprising a memory and a processor, wherein the memory stores at least one computer program, and the processor, when running the at least one computer program, is caused to perform:
receiving, in a process of displaying an original image, an instruction triggered by a target selection operation of a user on the original image, wherein the target selection operation comprises one of an operation of selecting a reserved area in the original image and an operation of selecting a removed area in the original image;
displaying, on the original image, a trajectory of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes; and
displaying, in response to an operation indicating to complete the selection and triggered by the user, a result after executing a corresponding image editing operation on the original image based on the trajectory according to the type of the target selection operation.

14. The electronic device according to claim 13, wherein the processor, when running the at least one computer program, is caused to perform:
receiving an instruction triggered by an erasing operation, wherein the erasing operation is configured to indicate to erase at least part of the trajectory; and
displaying a remaining trajectory after erasing on the original image, and highlighting an acting position of the erasing operation.

15. The electronic device according to claim 14, wherein the processor, when running the at least one computer program, is caused to perform:
displaying an erased trajectory, wherein the remaining trajectory and the erased trajectory have different display modes.

16. The electronic device according to claim 13, wherein the processor, when running the at least one computer program, is caused to perform:
representing, based on an acting position of the target selection operation and the type of the target selection operation, the trajectory by binary data; and
displaying, in response to the operation indicating to complete the selection and triggered by the user, the result after executing the corresponding image editing operation on the original image based on the trajectory according to the type of the target selection operation comprises:
displaying, in response to the operation indicating to complete the selection and triggered by the user, the result after executing the corresponding image editing operation on the original image based on the trajectory represented by the binary data according to the type of the target selection operation.

17. The electronic device according to claim 13, wherein the processor, when running the at least one computer program, is caused to perform:
representing, in response to the operation indicating to complete the selection and triggered by the user, the trajectory by binary data based on an acting position of the target selection operation and the type of the target selection operation; and
displaying, in response to the operation indicating to complete the selection and triggered by the user, the result after executing the corresponding image editing operation on the original image based on the trajectory according to the type of the target selection operation comprises:
displaying, in response to the operation indicating to complete the selection and triggered by the user, the result after executing the corresponding image editing operation on the original image based on the trajectory represented by the binary data according to the type of the target selection operation.

18. The electronic device according to claim 13, wherein the processor, when running the at least one computer program, is caused to perform:
sending the trajectory and the original image to a server;
receiving the result after executing the corresponding image editing operation on the original image by the server based on the trajectory according to the type of the target selection operation; and
displaying the result.

19. The electronic device according to claim 13, wherein the processor, when running the at least one computer program, is caused to perform:
acquiring and displaying the result by executing, based on the trajectory according to the type of the target selection operation, the corresponding image editing operation on the original image.

20. A non-transitory computer-readable storage medium storing at least one computer program thereon, wherein the at least one computer program, when run by a processor, causes the processor to perform:
receiving, in a process of displaying an original image, an instruction triggered by a target selection operation of a user on the original image, wherein the target selection operation comprises one of an operation of selecting a reserved area in the original image and an operation of selecting a removed area in the original image;
displaying, on the original image, a trajectory of the target selection operation acting on the original image, wherein an end of the trajectory is highlighted, a trajectory display mode is determined, based on a type of the target selection operation, in the trajectory display modes corresponding to types of a plurality of selection operations, and the plurality of selection operations correspond to different trajectory display modes; and
displaying, in response to an operation indicating to complete the selection and triggered by the user, a result after executing a corresponding image editing operation on the original image based on the trajectory according to the type of the target selection operation.
